(19) United States
(12) Patent Application Publication
(10) Pub. No.: US 2023/0385550 A1
(43) Pub. Date: Nov. 30, 2023

(54) DETECTING PEER PRESSURE USING MEDIA CONTENT INTERACTIONS

(71) Applicant: INTERNATIONAL BUSINESS MACHINES CORPORATION, ARMONK, NY (US)

(72) Inventors: Yuriko Nishikawa, Koto-ku (JP); MIKI ISHIKAWA, Yokohama (JP); YOKO SETTA, Shinagawa-ku (JP); Yoko Nameki, Tokyo (JP)

(21) Appl. No.: 17/804,232

(22) Filed: May 26, 2022

(51) Int. Cl. G06F 40/289; G06Q 50/00; G06N 20/00

(52) U.S. Cl. CPC G06F 40/289; G06Q 50/01; G06N 20/00

(57) ABSTRACT

A method, computer system, and a computer program for detecting peer pressure is provided. The present invention may include receiving at least one input including a contentious statement relating to a topic and detecting a plurality of media content associated with the topic. The present invention may then include determining a plurality of social interactions including at least one aggregation associated with the plurality of media content. The present invention may further include calculating a plurality of balance values associated with the plurality of social interactions based on the at least one aggregation. The present invention may further include outputting a plurality of time-series data associated with the plurality of balance values.

### BACKGROUND

The present invention relates generally to information processing, and in particular, to detecting peer pressure using media content interactions.

Due to the significant increase of reliance on media content for communication purposes due to social restrictions, a drastic influx of conflicted opinions have surfaced increasing the presence of “social bullying”. For example, social media has historically been a mechanism for soliciting opinions regarding pressing issues across a wide spectrum of matters; however, due to the aforementioned social practices inflicted it has created a significant hurdle in ascertaining data pertaining to not only the flow of opinions regarding topics, but also the underlying cause of variations of opinions most likely attributed to peer pressure. In light of the massive volumes of data being continuously collected by social networking services and media platforms, it is necessary to detect and analyze data altering factors such as peer pressure in order to preserve reliability of the data.

### SUMMARY

Additional aspects and/or advantages will be set forth in part in the description which follows and, in part, will be apparent from the description, or may be learned by practice of the invention.

Embodiments of the present invention disclose a method, system, and computer program product for detection of peer pressure in electronic content. According to one embodiment, a computing device for detection of peer pressure in electronic content includes a processor, and a memory coupled to the processor. The memory stores instructions to cause the processor to perform acts including: receiving at least one input including a contentious statement relating to a topic; identifying a plurality of media content associated with the topic; identifying a plurality of social interactions including at least one aggregation associated with the plurality of media content; calculating a plurality of balance values associated with the plurality of social interactions based on the at least one aggregation; and outputting a plurality of time-series data associated with the contentious statement; wherein the plurality of time-series data is configured to be utilized by the computing device to generate a metric indicating peer pressure derived from the plurality of balance values.

In one embodiment, the computer is configured to train a neural network deep learning model to compute a time series modeling and the one or more time series forecasts. The use of a neural network increases the efficiency of the time series modeling and forecasting.

### BRIEF DESCRIPTION OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a functional block diagram illustrating a computational environment for detecting peer pressure according to at least one embodiment;

FIG. 2 illustrates an exemplary block diagram illustrating a data flow associated with the environment of FIG. 1, according to at least one embodiment;

FIG. 3 illustrates a flowchart illustrating a process for collecting social media interactions, according to at least one embodiment;

FIG. 4 illustrates a flowchart illustrating a process for detecting peer pressure according to at least one embodiment;

FIG. 5 depicts a block diagram illustrating components of the software application of FIG. 1, in accordance with an embodiment of the invention; and

FIG. 6 depicts a cloud-computing environment, in accordance with an embodiment of the present invention

FIG. 7 depicts abstraction model layers, in accordance with an embodiment of the present invention.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

The following described exemplary embodiments provide a method, computer system, and computer program for detecting peer pressure in media content interactions. Social networking services and internet-based media outlets serve as popular forums for individuals to express their ideas and opinions pertaining to a wide spectrum of matters. In particular, various social networking services and media outlets include functionality that supports receiving inputs from users that reflects their sentiments regarding a particular issue/theme/etc. presented on the applicable platform. For example, the “like” and “share” functions respectively allow users to express a positive sentiment towards media content and distribute said content to other users on applicable platforms. However, there is a lack of data pertaining to the flow and/or volatility of a user's and/or group of users' sentiments towards a particular topic or piece of media content. Lack of said data can result in the elimination of thoughts and opinions that establish spectrum of sentiments regarding media content. For example in instances where various opinions are exchanged on applicable platforms, a “tuning pressure” can incite a majority opinion and due to the voluminous amount of data being received the minority opinion may inadvertently be eliminated. In addition, due to the voluminous amounts of data transmitted and processed by social networking services and internet-based media outlets, there historically is an exhaustive amount of computing resources required to continuously process media content (e.g., scalable machine learning models, natural language processing systems, etc.), much less perform analytics on social interactions associated with media content. For example, recurrent neural networks (RNN) are commonly used to recognize patterns in sequences of data, such as text, handwriting, spoken word, etc.; however, efficiency and optimization of these networks are limited due to the substantial amount of computing resources required. As such, the present embodiments have the capacity to improve analytics of social media interactions via detecting indicators of peer pressure, but also to improve the field of computing overall by providing machine learning models and natural language processing techniques that reduce the amount of computing resources required to operate efficient networks.

As described herein, the term “media content” is used to mean audio, video, images, text, blogs, webpages, tweets, and/or any combination thereof configured for presentation to a user or on a display.

As described herein, the term “social media interaction” may denote likes, comments, posts, shares, messages (e.g., direct/private messages, etc.), clicks, user reactions to the aforementioned, or any other applicable exchange between a user and media content and/or other users operating on an applicable platform known to those of ordinary skill in the art.

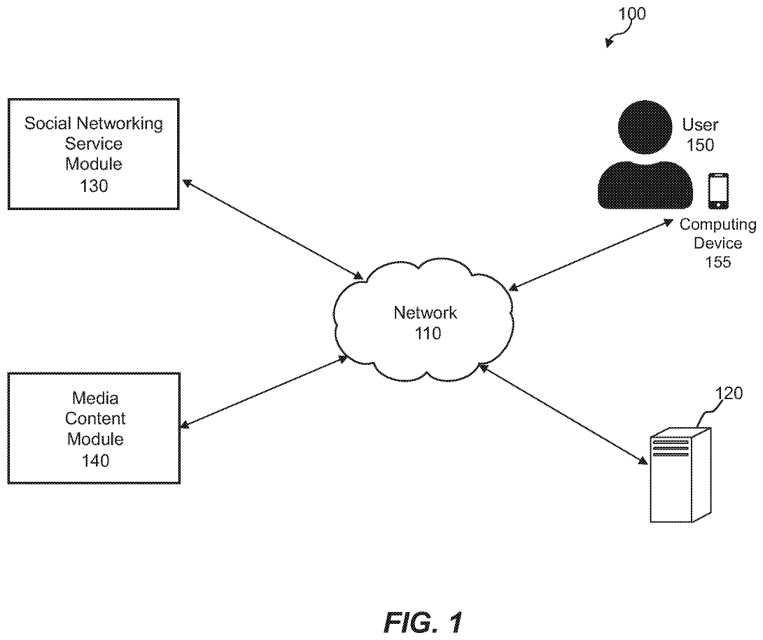

Referring now to FIG. 1, a peer pressure detection environment 100 is depicted, according to an exemplary embodiment. FIG. 1 provides only an illustration of implementation and does not imply any limitations regarding the environments in which different embodiments may be implemented. Modifications to environment 100 may be made by those skilled in the art without departing from the scope of the invention as recited by the claims. In various embodiments, environment 100 includes a server 120, a social networking service module 130, a media content module 140, and a computing device 155 associated with a user 150, in which each of the aforementioned components are communicatively coupled to server 120 over network 110. Network 110 may include various types of communication networks, such as a wide area network (WAN), local area network (LAN), a telecommunication network, a wireless network, a public switched network and/or a satellite network, etc. In some embodiments, network 110 may be embodied as a physical network and/or a virtual network. A physical network can be, for example, a physical telecommunications network connecting numerous computing nodes or systems such as computer servers and computer clients. A virtual network can, for example, combine numerous physical networks or parts thereof into a logical virtual network. In another example, numerous virtual networks can be defined over a single physical network. In some embodiments, network 110 is configured as public cloud computing environments, which can be providers known as public cloud services providers. Embodiments herein can be described with reference to differentiated fictitious public computing environment (cloud) providers. Computing device 155 can be implemented in the form of any system including a processor and memory that is capable of performing the functions and/or operations described within this specification. For example, computing device 155 can be, for example, an e-book reader, a tablet computer, a smart phone, a mobile computer, a laptop computer, a netbook computer, a desktop computer, or any applicable type of computing devices capable of running a program, accessing a network, and/or accessing databases. It should be appreciated that FIG. 1 provides only an illustration of one implementation and does not imply any limitations with regard to the environments in which different embodiments may be implemented. Many modifications to the depicted environments may be made based on design and implementation requirements.

In some embodiments, social networking service module 130 is configured to continuously collect and process social networking derived media content and/or social media streams sourced from one or more of Facebook®, Instagram®, Twitter®, Foursquare®, or any other applicable social networking service/electronic media source known to those of ordinary skill in the art, presently existing or after-arising. Social networking service module 130 may include one or more databases configured to serve as repositories for social networking service derived media content and/or data records associated with users of the aforementioned social networking services. It should be noted that media content, data collected by server 120, and/or data derived from media content processed by social networking service module 130 and media content module 140 may be configured to be processed as a plurality of data points at regular time intervals, received over a time window. The time intervals are typically uniform. The time series may comprise pairs or tuples reflecting time and one or more values of data points at each time, in which each tuple is configured to be stored in one or more of the databases. The values of time series may be derived from one or more of server 120, modules 130 and 140, the received signals, and/or data within the aforementioned databases associated with the modules. In some embodiments, the signals of a time series may comprise values and a measurand in which the measurand may be a physical quantity, quality, condition, or property being measured.

It should be further noted that one of the purposes of social networking service module 130 is to ascertain analytics pertaining to user 150 based upon his/her social interactions within the applicable social media platform. For example, based upon the amount of likes social network service derived media content associated with user 150 receives, social networking service module 130 may ascertain the amount of influence that user 150 has over an audience pertaining to a given topic. In some embodiments, social networking service module 130 may utilize various alternative factors in order to measure the relative influence over one or more entities/audiences (e.g. individuals or groups). Alternative factors may include, but are not limited to applicable demographics (gender, age, etc.), geographic location/origin, firmographics, or any other applicable nexuses among social networking service users. Entities/audiences may include members of a social media community, organization, or a group of organizations, observers or recipients of information, objects and/or events, a subset thereof, and/or any applicable combination thereof. It should be noted that information generated as a result of social interactions associated with social networking service module 130 inherently may be ambiguous and sometimes difficult to understand due to the personality of the individual associated with the social interactions (i.e., person who is posting). The person viewing the social interactions may misinterpret or misunderstand what is being communicated. Thus, a person of ordinary skill in the art will appreciate that one or more embodiments are directed to issues which are necessarily rooted in computer technology in order to overcome a problem specifically arising in the realm of computer networks. In some embodiments, data collected by server 120 from social networking service module 130, media content module 140, and other applicable ascertainable data sources may be processed utilizing sentiment analyses in order to discover overall sentiment or tone associated with one or more social interactions associated with user 150. The ascertained sentiment or tone may be utilized to assist the detection of peer pressure due to the apparent shift of sentiment or tone associated with a social media interaction. For example, user 150 may post a statement such as “The underlying reasons for this bill are ridiculous!” in which the response of their social media network may at first be in the affirmation/supportive; however, as social media interactions regarding the post may accumulate the overall sentiment or tone may shift due to a conflicting perspective held by the majority. Thus, one or more cognitive services may be provided by server 120 in order to capture analytics associated with the social media interactions, in which said cognitive services may include but are not limited to software supporting components such as Natural Language Understanding Concept Expansion, Concept Insights, Dialog, Document Conversion, Language Translation, Natural Language Classifier, Personality Insights, Relationship Extraction, Retrieve and Rank, Tone Analyzer, and/or any other applicable cognitive services known to those of ordinary skill in the art.

It should be noted that media content module 140 is configured to continuously receive data from media sources that are not accounted for by social networking service module 130 including but not limited to internet-based news networks, question/answer sites, blogs, and/or any other applicable source for Internet-based media content.

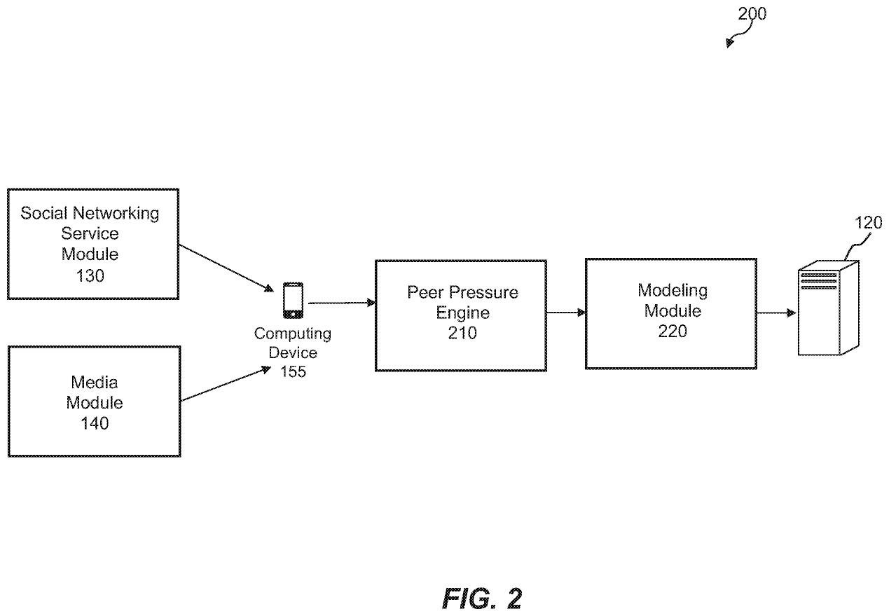

In a preferred embodiment, social networking service module 130 and media content module 140 are designed to transmit one or more social interactions received from user 150 via one or more inputs on computing device 155 to server 120 in order to for server 120 to process the received data with assistance from the one or more engines and modules discussed in greater detail in FIG. 2. In some embodiments, server 120 includes a Natural Language Classifier configured to apply cognitive computing techniques to return best matching predefined classes for short text inputs, such as a sentence or phrase or text transcribed from speech. Natural Language Classifiers (“NLCs”) are based on Natural Language Understanding (NLU) technology (previously known as “Natural Language Processing”). NLU is a field of computer science, artificial intelligence (AI) and computational linguistics concerned with the interactions between computers and human (natural) languages. Server 120 may further include one or more natural language processing (NLP) techniques in order to not only ascertain the topic the one or more social interactions apply to, but also to determine if the one or more social interactions are deemed a contentious statement based on the ascertained sentiment or tone of user 150 or reacting users. Referring to the previous example, server 120 may determine that the post “The underlying reasons for this bill are ridiculous!” is a contentious statement based off of the NLC and NLP techniques detecting words/phrases indicating intense emotion, in which the aforementioned techniques not only predict the class that best captures what is being expressed in that social media interaction, but also identifies and extracts contextual elements such as meaning, syntax, time, location, appropriate domain, regulations, user's profile, process, task/goal, etc. In some embodiments, the aforementioned techniques may draw on multiple sources of information, including both structured and unstructured digital information, as well as sensory inputs (e.g., visual, gestural, auditory and/or sensor-provided). For example, a sensor (e.g., a camera) associated with computing device 155 may detect visuals expressions, gestures, etc. of user 155 during the process of posting the applicable social media interaction in order to support the determination of server 120 pertaining to sentiment/tone and whether the social media interaction is a contentious statement. In some embodiments, server 120 may utilize one or more NLU processes for preparation of records that are stored in a database and for other purposes can be used for topic classification in which server 120 determines the topic of the contentious statement and outputs one or more topic NLU output parameters and sentiment output parameters. For example, based on the social media interaction posted by user 155 server 120 may determine NLU output parameters and sentiment output parameters that indicate “anger,” “disgust,” “fear,” “joy,”, “sadness”, etc. In some embodiments, the aforementioned outputs and components may be used in training sets for applicable models (e.g., machine learning, NLP, etc.). In some embodiments, topic analysis for topic classification and output of NLU output parameters may include topic segmentation performed by server 120 to identify several topics within a social media interaction. Topic analysis can apply a variety of technologies e.g. one or more of Hidden Markov model (HMM), artificial chains, passage similarities using word co-occurrence, topic modeling, clustering, etc. Sentiment analysis for sentiment classification and output of one or more sentiment NLU parameter can determine the attitude of user 150 and/or a “poster” with respect to some topic or the overall contextual polarity of a social media interaction (i.e., consensus of a group regarding a social media interaction).

Referring now to FIG. 2, a data flow 200 associated with peer pressure detection environment 100 is depicted, according to an exemplary embodiment. In some embodiments, server 120 is communicatively coupled to a peer pressure engine 210 and a modeling module 220 each of which are configured to transmit processed data to server 120 over network 110. It should be noted that one of the purposes of peer pressure engine 210 is to monitor social media interactions received from social networking service module 130 and media content module 140 in order to detect deviation of sentiment, tone, and overall setting of social media interactions pertaining to a particular topic derived from the contentious statement and reactions of others to the contentious statement. For example, social networking service module 130 and media content module 140 continuously transmit media content to computing device 155 in which user 150 provides the one or more inputs on computing device 155 in response to the media content.

Modeling module 220 can be employed by numerous technologies to determine inferences and/or relationships among digital data. For example, machine learning technologies, signal processing technologies, image processing technologies, data analysis technologies and/or other technologies can employ machine learning models to analyze digital data, process digital data, determine inferences from digital data and/or determine relationships among digital data. Often times digital data is formatted as time series data. In a preferred embodiment, time series data can be a sequence of data that is repeatedly generated and/or captured by a device (e.g., computing device 155) at a plurality of time values during the time intervals. Embodiments described herein include systems, computer-implemented methods, and computer program products that facilitate machine learning process using time series data via modeling module 220. For example, feature representation of time series data can be learned to facilitate employment of the time series data by modeling module 220. Time series representation learning for machine learning can be accomplished via dynamic time warping where time data for different streams of time series data is modified and/or correlated while preserving temporal information of the different streams of time series data. In a preferred embodiment, the plurality of time series data is representative of supportive or opposing reactions of social media users to supportive or opposing social media interactions associated with the contentious statement in which the total number of supportive or opposing reactions are calculated by time unit based on the date, time, and/or other applicable metadata of the reaction. In some embodiments, time unit for the calculation (e.g., daily, weekly, monthly, etc.) is specified in advance. Once applicable weights are applied to the calculation (e.g., amount of influence of the contributor, opposition based on reaction is trending, etc.), the total may be presented on computing device 155 by the applicable time unit.

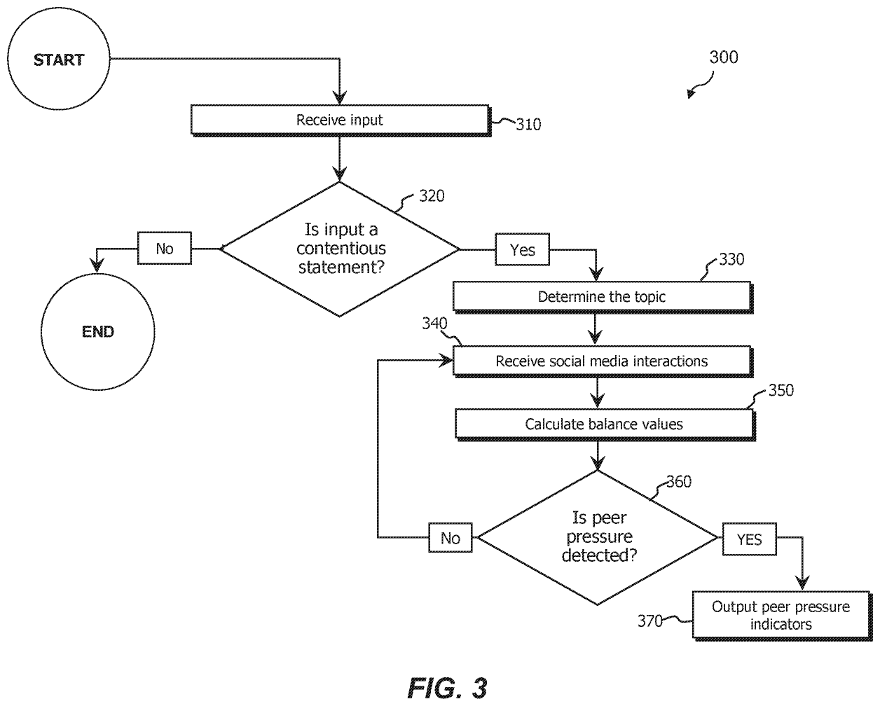

In some embodiments, server 120, independently or with assistance from modeling module 220 utilizes NLP techniques to determine whether the inputs include a contentious statement along with the applicable topic the contentious statement pertains to. Upon detection of a contentious statement and topic, server 120 transmits the data to peer pressure engine 210 in which peer pressure engine 210 filters the media content provided to computing device 155 in order to identify a subset of the media content that pertains to the topic. In some embodiments, peer pressure engine 210 may include one or more web crawlers configured to traverse various media sources in order to collect relevant data pertaining to the topic once ascertained from the contentious statement. Peer pressure engine 210 may utilize modeling module 220 which is configured to generate a Recurrent Neural Network (RNN) to analyze the contentious statement for improved language comprehension purposes. Modeling module 220 utilizes weights and parameters trained (iteratively refined) using training samples of social media interactions and derivatives thereof fed into the neural network. Weights and parameters utilized by modeling module 220 may include but are not limited to a degree of popularity of the topic, amount of influence of user 155 (e.g., number of followers, standing in the community, amount of activity within network, etc.), level of support of network members pertaining to the social media interaction, or any other applicable social media interaction metrics known to those of ordinary skill in the art. The purpose in using these weights/parameters is to not allow peer pressure engine 210 to establish one or more aggregations of social media interactions relating to the contentious statement, the applicable topic, and/or the subset of media content; but also to apply said weights/parameters to the evaluation of balance values as described in greater detail in reference to FIGS. 3 & 4. In some embodiments, the one or more aggregations are compilations of social media interactions that are grouped and/or clustered based upon one or more similarities to the contentious statement. The similarities may be ascertained via utilizing natural language processing, TF/IDF frequency within the social media interactions, one or more outputs of modeling module 220, clustering algorithms (e.g., Euclidean distance, Manhattan distance, etc.), or any other applicable grouping mechanisms known to those of ordinary skill in the art.

Alternatively, the deviation of overall sentiment pertaining to a social media interaction may account for a series of social media interactions pertaining to a particular topic in which peer pressure engine 210 may utilize modeling module 220 which is configured to construct machine learning models based on training sets including data derived from peer pressure engine 210 to generate one or more outputs, said outputs configured to include one or more balance values associated with the social media interactions. In some embodiments, the one or more outputs may be utilized by server 120 to generate one or more metrics indicating peer pressure associated with social media interactions associated with user 150. Server 120 may utilize modeling module 220 in order to identify topics associated with social media interactions. For example, modeling module 220 may utilize NLP techniques to ascertain the applicable topic of the social media interaction along with the whether the social media interaction is a contentious statement. Modeling module 220 may evaluate conversations against multiple support vector machines (SVMs) and classify the social media interaction using deep teaming (e.g., convolutional neural networks). For example, peer pressure engine 210 may parse and process data derived from the social media interactions in order to determine relative influence of user 150 over their social network regarding a particular topic, which may be manifested in one or more influence scores configured to be utilized by modeling module 220.

Peer pressure engine 210 is configured to detect media content sourced from social networking service module 130, media content module 140, and/or any other applicable media source based upon the relevant topic derived from the contentious statement. In a preferred embodiment, peer pressure engine 210 continuously collects time series data; however, peer pressure engine 210 is also configured to collect various types of data associated with user 150 and the applicable platforms including but not limited to unstructured text-data, multimedia data, etc. In some embodiments, the time-series data is collected based on the plurality of social media interactions allowing peer pressure engine 210, with assistance from modeling module 220, to ascertain metadata associated with the social media interactions. The metadata may include timestamped values indicating favor or opposition to a particular social media interaction allowing modeling module 220 to generate the one or more balance values associated with the social media interactions. It should be noted that the degree of divergence between the balance values output by modeling module 220 allow peer pressure engine 210 to determine not only if the contentious statement is influencing the environment, but also to determine analytics pertaining to the influence such as majority/minority opinion, turning point metrics, shift in topic, etc. Peer pressure engine 210 also utilizes the sentiment analyses functionality in order to ascertain syntactic tone in social media interactions such as type-written messages, and transmits the derived data to modeling module 220 to optimize outputting of the balance values. For example, user 150 may manually input a controversial social media interaction such as a post regarding an applicable topic, and peer pressure engine 210 is continuously calculating the amount of responses to the social media interaction both negative and positive in order to ascertain the current sentiment. In some embodiments, peer pressure engine 210 is configured to aggregate one or more summaries pertaining to a particular topic and/or data source (e.g., news article, social media link, etc.) using key point analysis APIs in which upon peer pressure engine 210 determining the aggregation is contentious and pertains to a particular topic, data may be derived thereof for training data sets to be utilized by modeling module 220.

In some embodiments, peer pressure detection by peer pressure engine 210 is subject to the topic analysis in which peer pressure engine 210 may apply a variety of technologies e.g. one or more of Hidden Markov model (HMM), artificial chains, passage similarities using word co-occurrence, topic modeling, or clustering. Peer pressure engine 210 utilizing sentiment analysis for sentiment classification allows outputting of one or more sentiment NLU parameters configured to establish the sentiment/attitude of user 150 and a subsequent poster/commenter with respect to the applicable topic or the overall contextual polarity of the social media interaction. The attitude may be the judgment or evaluation of user 150, affective state (the emotional state of user 150 when writing), or the intended emotional communication (emotional effect user 150 wishes to have on their social media network).

It should be noted that various decision data structures can be used to drive artificial intelligence (AI) decision making performed by modeling module 220, such as decision data structure that cognitively maps social media interactions in relation to posted content in respect to parameters for use in better classification of contentious statements and shift of overall sentiment regarding a social media interaction. Decision data structures as set forth herein can be updated by machine learning so that accuracy and reliability is iteratively improved over time without resource consuming rules intensive processing. Machine learning processes can be performed for increased accuracy and for reduction of reliance on rules based criteria and thus reduced computational overhead. For enhancement of computational accuracies, embodiments can feature computational platforms existing only in the realm of computer networks such as artificial intelligence platforms, and machine learning platforms.

For enhancement of computational accuracies, embodiments can feature computational platforms existing only in the realm of computer networks such as artificial intelligence platforms, and machine learning platforms provided by modeling module 220. Modeling module 220 is configured to employ data structuring processes, e.g. processing for transforming unstructured data into a form optimized for computerized processing. Embodiments herein can examine data from diverse data sources such as data sources that process radio or other signals for analytics of users. Embodiments herein can include artificial intelligence processing platforms featuring improved processes to transform unstructured data into structured form permitting computer based analytics and decision making. Embodiments herein can include particular arrangements for both collecting rich data into a data repository and additional particular arrangements for updating such data and for use of that data to drive artificial intelligence decision making performed by modeling module 220.

Referring now to FIG. 3, a flowchart illustrating a process for collecting social media interactions 300 is depicted, according to exemplary embodiment. It should be understood that process 300 is configured to facilitate not only the collection of social media interactions, but also the determination of supporting data, weights, parameters, and other applicable data components associated with the collection and analyses of social media interactions. At step 310, server 120 receives one or more inputs of user 150 from computing device 155 over network 110. In some embodiments, the one or more inputs may include expressions of user 150 including but not limited to social media/internet platform posts, detected gestures (e.g., facial gestures captured via an associated sensor of computing device 155), reactions to internet-based content, or any other type of input known to those of ordinary skill in the art. For example, user 150 may create a social media interaction, such as a post on social media and/or comment on an internet-based media forum, in which social networking module 130 and/or media content module 140 transmits the social media interaction, associated metadata of the social media interaction, along with one or more detected gestures of user 150 to server 120.

At step 320, server 120, with the assistance of modeling module 220, makes a determination pertaining to if the one or more inputs include contentious statements. It should be noted that determination step 320 may be based on one or more of the aforementioned NLP techniques including but not limited to sentiment analyses, machine logic-based rules for content collection, knowledge acquired from previous iterations of modeling module 220, or any other applicable data configured to be ascertained by server 120. For example, based on expressions of user 150 detected via computing device 155 while typing the one or more inputs, server 120 may ascertain via NLU output parameters and sentiment output parameters that indicate “anger” supporting that the one or more inputs include a contentious statement. If server 120 determines the one or more inputs indicate a contentious statement, then step 330 occurs; otherwise, server 120 continues to collect relevant data from social networking service module 130 and/or media content module 140.

At step 330, based on the determination of the one or more inputs including or indicating a contentious statement, server 120 utilizes one of more of the NLP techniques to determine the applicable topic associated with the contentious statement. In some embodiments, server 120 includes one or more filtering modules configured to filter data received by server 120 based on content within the one or more inputs and/or the reactions to a social media interaction. Topics can be ascertained from associations of topics with specific words, phrases, or sentences (e.g., an association of a topic with n-gram or the subject noun of a sentence). The filtering can be based on a conceptual “closeness of” or “distance between” topics. The distance between topics can be defined by an ontology or topological mapping of topics based on data derived from one or more of server 120, computing device 155 (e.g., search history/digital footprints of user 150), previous iterations of modeling module 220, etc. It should be noted that as server 120 is determining the applicable topic associated with the contentious statement, social networking service module 130 and/or media content module 140 are continuously transmitting and filtering social media interactions to server 120 over network 110 allowing peer pressure engine 210 to determine metadata and analytics of the social media interactions associated with the contentious statement. In some embodiments, server 120 and/or peer pressure engine 210 are configured to generate an aggregation of contentious statements pertaining to a particular topic derived from a media source. For example, an internet-based article received from media content module 140 may include a plurality of contentious statements from various users in which server 120 and/or peer pressure engine 210 aggregates the contentious statements into one or more summaries configured for server 120 to transmit to modeling module 220 for training dataset utilization purposes. It should be noted that the contentious statements are aggregated into a centralized location based upon server 120 determining each contentious statement pertains to the same topic utilizing the aforementioned NLP processes.

At step 340, server 120 collects additional social media interactions from social networking service module 130 and media content module 140. The purpose of server 120 collecting the additional social media interactions is to not only account for comments, reactions (e.g., likes, sharing, etc.), and other applicable social media interactions of other users to the contentious statement of user 150 in real-time, but also assisting peer pressure engine 210 with establishing one or more aggregations of social media interactions relating to the contentious statement, the applicable topic, and/or the subset of media content. Server 120 may transmit the tailored additional social media interactions to modeling module 220 for detection of weights and parameters impacting the detection of peer pressure associated with the contentious statement (e.g., overall reactions to the post of user 150).

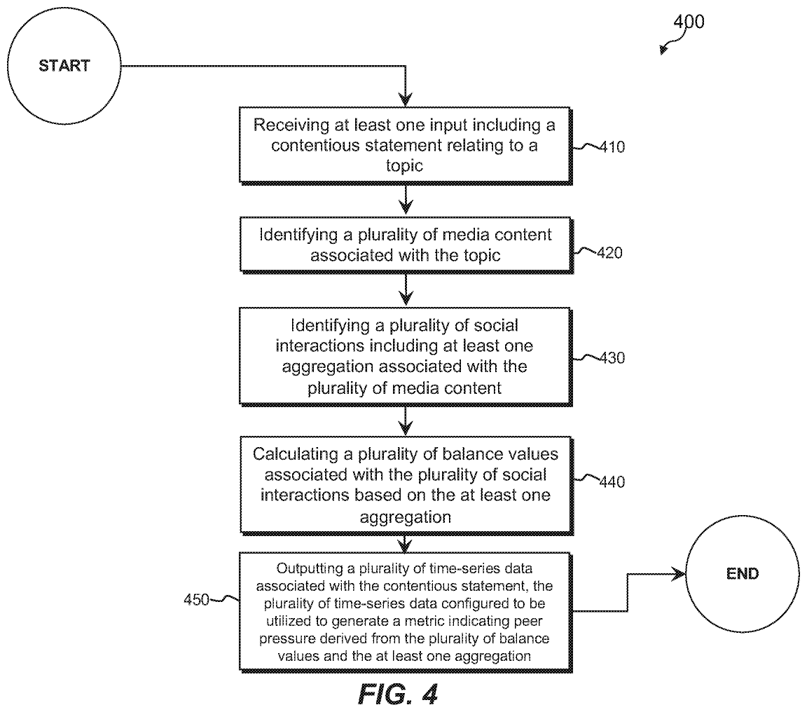

At step 350, peer pressure engine 210, with the assistance of modeling module 220 calculates a plurality of balance values associated with the social media interaction. In some embodiment, each social media interaction associated with the contentious statement is classified as either supportive or opposing the contentious statement, in which each social media interaction is timestamped and analyzed in order to determine one or more analytics (e.g., date, time, location, influence, etc. of social media interaction source). For example, peer pressure engine 210 may ascertain whether the user who provided the supportive or opposing social media interaction is an influencer, which may significantly impact the presence of peer pressure. Greater details pertaining to the calculation of balance values is provided herein in reference to FIG. 4.

At step 360, peer pressure engine 210 determines if peer pressure is detected with the plurality of social media interactions associated with the contentious statement. It should be understood that peer pressure engine 210 is continuously monitoring for changes and/or shifts of opinions and sentiments pertaining to the contentious statement in order to ascertain the presence of peer pressure caused by common societal factors such as tuning pressure. If peer pressure is detected by peer pressure engine 210, then step 370 occurs; otherwise, peer pressure engine 210 continues to receive additional social media interactions associated with the contentious statement from server 120.

At step 370, one or more peer pressure indicators are generated by peer pressure engine 210 and output to computing device 155. In some embodiments, the output of one or more peer pressure indicators may be a plurality of time series representations such as graphs, charts, or any other applicable means of visualization including supportive or opposing social medial interactions organized by time unit ascertained from the metadata.

Referring now to FIG. 4, an operational flowchart illustrating an exemplary process for detecting peer pressure 400 is depicted according to at least one embodiment.

At step 410, server 120 receives at least one input including a contentious statement relating to a topic. In some embodiments, the input may be a document corpus including news article pertaining to a particular topic or any other applicable media content configured to include social media interactions. It should be noted that server 120 continuously receives the social media interactions in which server 120 identifies analytics and metadata derived from the social media interactions of both user 150 and users that interact with the social media interactions of user 150. Server 120 may be configured to sequentially monitor the balance values and applicable data utilized to calculate the balance values in order to establish trends, patterns, etc.

At step 420, server 120 detects the plurality of media content associated with the topic ascertained from the established topic associated with the contentious statement. One of the underlying purposes of step 420 is to allow server 120 and other communicatively coupled components of environment 100 to continuously collect data configured to optimize subsequent iterations of modeling module 220. For example, data necessary for establishing parameters and weighting used for calculating influencing scores and/or amount of support relating to the social media interactions associated with user 150 may be acquired during step 420 in which modeling module 220 may utilize said data for training data dataset purposes and any other applicable machine learning processes. In light of the voluminous amount of media content being received by server 120, applying the filtering mechanism based on the ascertained topic associated with the contentious statement allows a reduction of data required to be processed by the computing resources associated with server 120.

At step 430, server 120 determines a plurality of social media interactions including the one or more aggregations associated with the plurality of media content received by server 120. The social media interactions are continuously classified as supportive or opposing based on the content of the applicable social media interaction; however, the aggregations are configured to be established based upon level of relevance to the applicable topic ascertained from the contentious statement. For example, a social media user may comment on the contentious statement of user 150 in which the content of the comment may be processed utilizing one or more of the aforementioned NLP processes in order to determine proper classification of the comment. It should be understood that social media interactions and allocation of scoring and/or classification of social media interactions may vary upon various factors including but not limited to source acquired from, substance of social media interaction, applied mechanism (e.g., like, share, comment, etc.), or any other ascertainable factor known to those of ordinary skill in the art.

At step 440, server 120 calculates a plurality of balance values associated with the plurality of social media interactions based on the one or more aggregations. In some embodiments, the plurality of balance values are outputs of modeling module 220 configured to be utilized by server 120 to generate the time series data. The plurality of balance values may be derived from one or more aggregation values associated with the contentious statement generated by peer pressure engine 210. In some embodiments, the amount of reactions to the social media interactions is factored into the calculation of the balance values in which said reactions may be classified as supporting or opposing the contentious statements and/or associated social interactions. The aggregation values may be a real number reflecting an accumulation of classification count (e.g., the total amount of social interactions) in which the aggregation values may be impacted based on weights and parameters associated with social media interactions. For example, in response to the contentious statement a user who is an influencer (e.g., individual with a large amount of followers) may reply/react to the contentious statement in the opposition in which said reply is classified as opposing based on the extracted content of the reply. Said opposing replies will include more weight due to the influencer status of the poster; thus, individuals such as verified accounts, public figures, experts, etc. will weigh significantly heavier on the calculation than others. In another example, in response to the contentious statement a user who is not an influencer may provide a supportive reply which is significantly supported by other users (e.g., a large amount of likes and/or shares) within the applicable social network indicating a strong wave/level of support. In both instances, peer pressure engine 210 calculates the total amount of social media interactions classified as supportive and the total amount of social media interactions classified as opposing in order to generate the balance values, which in some embodiments is a real number representing the extent for which the social media interaction supports or opposes the contentious statement. In some embodiments, the total amount of supportive social media interactions is counter-balanced by the total amount of opposing social media interactions based on the time unit derived from the date/time of each social media interaction in which the weighting parameters are applied during the calculation to adjust the balance values accordingly. In some embodiments, modeling module 220 forecasts the plurality of time-series data via utilizing a forecasting model configured to train training datasets derived from at least one of the aggregation created by server 120 and/or peer pressure engine 210. Peer pressure engine 210 may determine the presence of peer pressure based on the calculated balance values or the balance values may be metrics indicating a shift of the consensus from supportive to opposing or vice-versa.

At step 450, server 120 outputs the plurality of time series data associated with the contentious statement to computing device 155. In some embodiment, the plurality of time series data is configured to be utilized by modeling module 220 in order to generate one or more metrics indicating peer pressure derived from the plurality of balance values and the aggregation. In some embodiment, server 120 generates one or more visual representations of the time series data in order to accurately and efficiently depict the current public opinion pertaining to not only the contentious statement of user 150, but also regarding the applicable topic as a whole. The embodiments provided herein take into consideration reactions to the contentious statement in a manner that prioritizes quality of reactions based on content opposed to merely quantity.

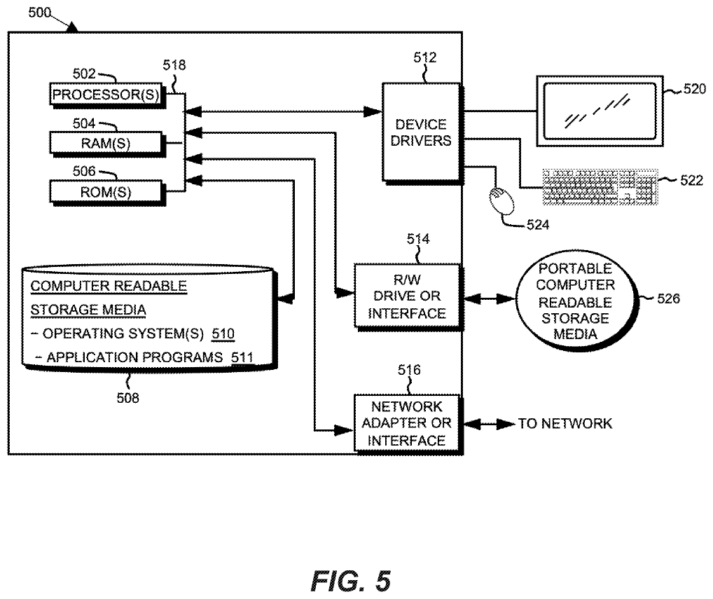

FIG. 5 is a block diagram of components 500 of computers depicted in FIG. 1 in accordance with an illustrative embodiment of the present invention. It should be appreciated that FIG. 5 provides only an illustration of one implementation and does not imply any limitations with regard to the environments in which different embodiments may be implemented. Many modifications to the depicted environments may be made based on design and implementation requirements.

Data processing system 502, 504 is representative of any electronic device capable of executing machine-readable program instructions. Data processing system 502, 504 may be representative of a smart phone, a computer system, PDA, or other electronic devices. Examples of computing systems, environments, and/or configurations that may represented by data processing system 502, 504 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The one or more servers may include respective sets of components illustrated in FIG. 5. Each of the sets of components include one or more processors 502, one or more computer-readable RAMs 508 and one or more computer-readable ROMs 510 on one or more buses 502, and one or more operating systems 514 and one or more computer-readable tangible storage devices 516. The one or more operating systems 514 and computing event management system 210 may be stored on one or more computer-readable tangible storage devices 516 for execution by one or more processors 502 via one or more RAMs 508 (which typically include cache memory). In the embodiment illustrated in FIG. 5, each of the computer-readable tangible storage devices 516 is a magnetic disk storage device of an internal hard drive. Alternatively, each of the computer-readable tangible storage devices 516 is a semiconductor storage device such as ROM 510, EPROM, flash memory or any other computer-readable tangible storage device that can store a computer program and digital information.

Each set of components 500 also includes a R/W drive or interface 514 to read from and write to one or more portable computer-readable tangible storage devices 508 such as a CD-ROM, DVD, memory stick, magnetic tape, magnetic disk, optical disk or semiconductor storage device. A software program, such as computing event management system 210 can be stored on one or more of the respective portable computer-readable tangible storage devices 508, read via the respective RAY drive or interface 518 and loaded into the respective hard drive.

Each set of components 500 may also include network adapters (or switch port cards) or interfaces 516 such as a TCP/IP adapter cards, wireless wi-fi interface cards, or 3G or 4G wireless interface cards or other wired or wireless communication links. COP 120 can be downloaded from an external computer (e.g., server) via a network (for example, the Internet, a local area network or other, wide area network) and respective network adapters or interfaces 516. From the network adapters (or switch port adaptors) or interfaces 516, the centralized platform is loaded into the respective hard drive 508. The network may comprise copper wires, optical fibers, wireless transmission, routers, firewalls, switches, gateway computers and/or edge servers.

Each of components 500 can include a computer display monitor 520, a keyboard 522, and a computer mouse 524. Components 500 can also include touch screens, virtual keyboards, touch pads, pointing devices, and other human interface devices. Each of the sets of components 500 also includes device processors 502 to interface to computer display monitor 520, keyboard 522 and computer mouse 524. The device drivers 512, R/W drive or interface 518 and network adapter or interface 518 comprise hardware and software (stored in storage device 504 and/or ROM 506).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Analytics as a Service (AaaS): the capability provided to the consumer is to use web-based or cloud-based networks (i.e., infrastructure) to access an analytics platform. Analytics platforms may include access to analytics software resources or may include access to relevant databases, corpora, servers, operating systems or storage. The consumer does not manage or control the underlying web-based or cloud-based infrastructure including databases, corpora, servers, operating systems or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

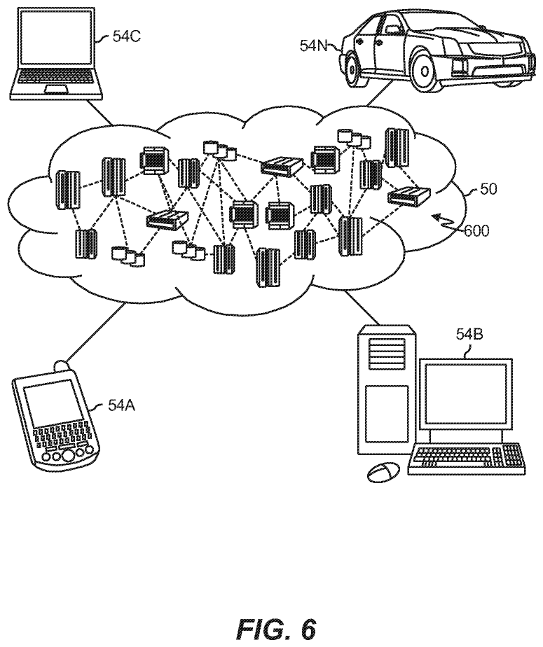

Referring now to FIG. 6, illustrative cloud computing environment 600 is depicted. As shown, cloud computing environment 600 comprises one or more cloud computing nodes 50 with which local computing devices used by cloud consumers, such as, for example, personal digital assistant (PDA) or cellular telephone 54A, desktop computer 54B, laptop computer 54C, and/or automobile computer system 54N may communicate. Nodes 50 may communicate with one another. They may be grouped (not shown) physically or virtually, in one or more networks, such as Private, Community, Public, or Hybrid clouds as described hereinabove, or a combination thereof. This allows cloud computing environment 600 to offer infrastructure, platforms and/or software as services for which a cloud consumer does not need to maintain resources on a local computing device. It is understood that the types of computing devices 54A-N shown in FIG. 6 are intended to be illustrative only and that computing nodes 50 and cloud computing environment 600 can communicate with any type of computerized device over any type of network and/or network addressable connection (e.g., using a web browser).

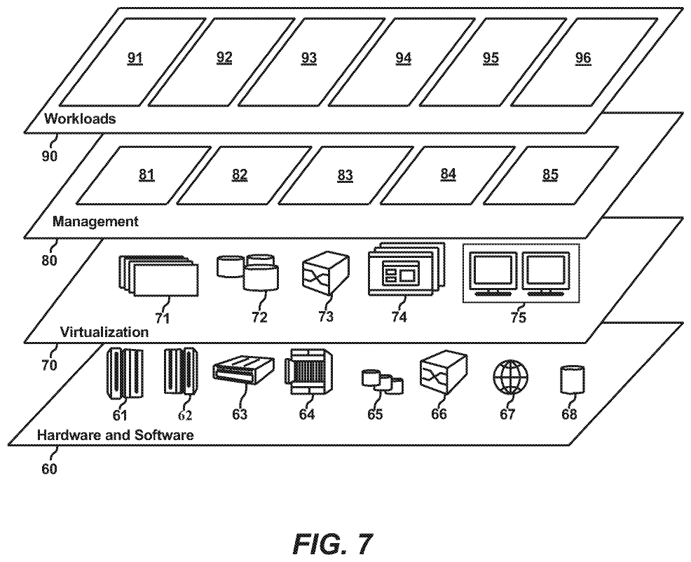

Referring now to FIG. 7 a set of functional abstraction layers provided by cloud computing environment 600 (FIG. 6) is shown. It should be understood in advance that the components, layers, and functions shown in FIG. 7 are intended to be illustrative only and embodiments of the invention are not limited thereto. As depicted, the following layers and corresponding functions are provided:
Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 66 and database software 68.
Virtualization layer 60 provides an abstraction layer from which the following examples of virtual entities may be provided: virtual servers 61; virtual storage 62; virtual networks 63, including virtual private networks; virtual applications and operating systems 64; and virtual clients 65.
In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.
Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; and transaction processing 95.

Based on the foregoing, a method, system, and computer program product have been disclosed. However, numerous modifications and substitutions can be made without deviating from the scope of the present invention. Therefore, the present invention has been disclosed by way of example and not limitation.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A computer-implemented method using a computing device for detection of peer pressure in electronic content, the method comprising:
receiving, by a computing device, at least one input including a contentious statement relating to a topic;
identifying, by the computing device, a plurality of media content associated with the topic;
identifying, by the computing device, a plurality of social interactions including at least one aggregation associated with the plurality of media content;
calculating, by the computing device, a plurality of balance values associated with the plurality of social interactions based on the at least one aggregation; and
outputting, by the computing device, a plurality of time-series data associated with the contentious statement, the plurality of time-series data configured to be utilized by the computing device to generate a metric indicating peer pressure derived from the plurality of balance values and the at least one aggregation.

2. The computer-implemented method of claim 1, wherein the plurality of media content is derived from at least one electronic media source or social networking service and the plurality of social interactions includes one or more likes, comments, shares, posts, and re-posts relating to the topic.

3. The computer-implemented method of claim 1, wherein calculating the plurality of balance values further comprises calculating the plurality of balance values based on a degree of influence of an individual providing a social interaction of the plurality of social interactions.

4. The computer-implemented method of claim 1, wherein calculating the plurality of balance values further comprises calculating the plurality of balance values based on a level of support within the plurality of social interactions.

5. The computer-implemented method of claim 1, wherein the at least one aggregation includes one or more of a first aggregation value representing positive sentiments and a second aggregation value representing negative sentiments pertaining to the contentious statement.

6. The computer-implemented method of claim 1, wherein calculating the plurality of balance values further comprises providing, by the computing device, a machine learning algorithm trained with a plurality of past social interactions, thereby having learned to derive from the plurality of social interactions the at least one aggregation configured to be utilized to ascertain the metric indicating peer pressure.

7. The computer-implemented method of claim 6, wherein the plurality of time-series data is forecasted by a model configured to utilize trainings sets derived from the at least one aggregation.

8. A computer program product using a computing device for detection of peer pressure in electronic content, comprising:
one or more non-transitory computer-readable storage media and program instructions stored on the one or more non-transitory computer-readable storage media, the program instructions, when executed by the computing device, cause the computing device to perform a method comprising:
receiving, by the computing device, a contentious statement from a user;
responsive to determining a topic associated with the contentious statement, detecting, by the computing device, a plurality of media content relating to the topic;
determining, by the computing device, a plurality of social interactions including at least one aggregation associated with the plurality of media;
calculating, by the computing device, a plurality of balance values associated with the plurality of social interactions based on the at least one aggregation; and
outputting, by the computing device, a plurality of time-series data associated with the contentious statement, the plurality of time-series data configured to be utilized by the computing device to generate a metric indicating peer pressure derived from the plurality of balance values and the at least one aggregation.

9. The computer program product of claim 8, wherein determining the topic associated with the contentious statement comprises: utilizing, by the computing device, a natural language processing (NLP) engine to determine the topic based on a social interaction of the plurality of social interactions derived from the user.

10. The computer program product of claim 8, wherein the plurality of media content is derived from at least one electronic media source or social networking service and the plurality of social interactions includes one or more likes, comments, shares, posts, and re-posts relating to the topic.

11. The computer program product of claim 8, wherein the at least one aggregation includes one or more of a first aggregation value representing positive sentiments and a second aggregation value representing negative sentiments pertaining to the contentious statement.

12. The computer program product of claim 8, wherein calculating the plurality of balance values comprises the processor further: calculating by the computing device, the plurality of balance values based on a degree of influence of an individual providing a social interaction of the plurality of social interactions.

13. The computer program product of claim 8, wherein calculating the plurality of balance values comprises: calculating by the computing device, the plurality of balance values based on a level of support within the plurality of social interactions.

14. The computer program product of claim 8, wherein calculating the plurality of balance values comprises: providing, by the computing device, a machine learning algorithm trained with a plurality of past social interactions, thereby having learned to derive from the plurality of social interactions the at least one aggregation configured to be utilized to ascertain the metric indicating peer pressure.

15. The computer program product of claim 14, wherein the plurality of time-series data is forecasted by a model configured to utilize trainings sets derived from the at least one aggregation.

16. A computer system for detection of peer pressure in electronic content, the computer system comprising:
one or more processors, one or more computer-readable memories, and program instructions stored on at least one of the one or more computer-readable memories for execution by at least one of the one or more processors to cause the computer system to:
program instructions to receive a contentious statement from a user;
in response to program instructions to determine a topic associated with the contentious statement, program instructions to detect a plurality of media content relating to the topic;
program instructions to determine a plurality of social interactions including at least one aggregation associated with the plurality of media;
program instructions to calculate a plurality of balance values associated with the plurality of social interactions based on the at least one aggregation; and
program instructions to output a plurality of time-series data associated with the contentious statement, the plurality of time-series data configured to be utilized to generate a metric indicating peer pressure derived from the plurality of balance values and the at least one aggregation

17. The computer system of claim 16, wherein program instruction to determine the topic associated with the contentious statement further comprises program instructions to:
utilize a natural language processing (NLP) engine to determine the topic based on a social interaction of the plurality of social interactions derived from the user.

18. The computer system of claim 16, wherein the plurality of media content is derived from at least one electronic media source or social networking service and the plurality of social interactions includes one or more likes, comments, shares, posts, and re-posts relating to the topic.

19. The computer system of claim 16, wherein the at least one aggregation includes one or more of a first aggregation value representing positive sentiments and a second aggregation value representing negative sentiments pertaining to the contentious statement.

20. The computer system of claim 16, wherein the plurality of time-series data is forecasted by a model configured to utilize trainings sets derived from the at least one aggregation.
